(19) United States
(12) Patent Application Publication
(10) Pub. No.: US 2008/0169674 A1
(43) Pub. Date: Jul. 17, 2008

(54) Modular cargo containment wall system

(76) Inventor: Larry Robert Giles, Calgary (CA)

Correspondence Address: Antony C. Edwards, P.O. Box 26020, Westbank, BC, V4T 2G3, omitted

(21) Appl. No.: 11/653,945

(22) Filed: Jan. 17, 2007

(51) Int. Cl. B62D 33/02

(52) U.S. Cl. 296/183.1

(57) ABSTRACT

A modular cargo containment wall system includes a floor or floor liner, and first and second types of containment walls referred to herein alternatively as first and second wall members. The floor or floor liner has upwardly disposed parallel arrays of first tenons mounted thereon. The floor or floor liner are alternatively referred to herein are intended to encompass all manner of flooring or floor liners, whether or not removable.

### FIELD OF THE INVENTION

This invention relates to the field of cargo bed accessories for restraining cargo placed on the bed and in particular to a modular containment wall system for restraining cargo.

### BACKGROUND OF THE INVENTION

As indicated by the plethora of prior art of which applicant is aware, the more relevant of which are described below, is well known that securing cargo within an open cargo box, or on a cargo bed, for example on a vehicle is and apparently remains a problem. The utility of for example a pickup truck, is its versatility in the kinds of cargo loads that may be carried within the pickup truck box. However, because the pickup truck box is relatively large and devoid of baffles, compartments or other means to secure smaller items, smaller items during transport if not restrained may shift, roll, bounce or otherwise become freely unsecured which may result in damage to both the cargo and to the truck. Occasionally this may also prove to be a safety hazard where the cargo is, for example, relatively unstable gas cylinders such as propane tanks and the like. Consequently, what is needed is a modular containment wall system which is of relatively simple construct and simple to use, that is, simple to install, adjust, and store when not needed. Thus in the present invention, a system of interlocking containment walls is provided which cooperate with arrays of mating projections mounted into the floor of the cargo box or cargo carrying bed advantageously so that the load bearing surface of the bed shields the mating protrusions from harm when not in use and wherein the mating protrusions are easily cleaned in the event of fouling due to carrying a load of, for example, semi-solid material such as soils or like material.

In the field of cargo containment system, applicant is aware of the following prior art:

U.S. Pat. No. 4,917,429 which issued to Giger on Apr. 17, 1990 for a Truck Bed Divider Assembly which discloses a portable divider assembly for dividing a pickup truck bed having a flat floor and spaced side walls into at least two smaller compartments without use of tools or modification of the truck bed and without attachment to the truck bed so that the divider assembly may be freely applied to compartmentalize the truck bed or removed to restore the truck bed to its non-compartmentalized condition. The portable divider assembly is formed from an elongated center divider panel and a plurality of cross member panels.

U.S. Pat. No. 5,044,682 which issued to Wayne on Sep. 3, 1991 for a Pickup Truck Bed Linder Divider Insert which discloses a bed liner divider system for interfitting with tapered, V-shaped slots defined in the bed liner of a pick-up truck and the like comprises one or more removable divider portions and at least one removable insert slottingly fittable within at least one of the tapered slots. The insert includes a tapered base portion for interattachment with the slot and a channel portion for removably receiving the divider portion. The insert has a wider upper part relative to a narrower lower part. The insert may be permanently fastened to the bed liner. The insert may be of one-pieced construction.

U.S. Pat. No. 5,259,712 which issued to Wayne on Nov. 9, 1993 for a Vehicle Cargo Area Divider System which discloses a divider system for the cargo area of a vehicle is provided comprising one or more dividers and inserts for bracing the dividers. The inserts are of two embodiments. In the first embodiment, a tapered, V-shaped insert is provided for attachment to the slots conventionally provided in a vehicle bed liner. In the second embodiment, an insert is provided that is attachable to the inner wall of a vehicle's cargo area which does not necessarily attach to a liner. The second embodiment is held in place by either an adhesive or a clamping assembly.

U.S. Pat. No. 5,240,301 which issued to Arnold on Aug. 31, 1993 for a Bed Liner Having Integral Cargo Restraint Capability which discloses a bed liner for pick-up trucks incorporating the features of multi-component construction, releasable connection with the side-walls, and an integral, nonintrusive cargo restraint capability. Specifically, the bed liner is composed of a durable, resilient material with individual panels for each longitudinal side-wall, floor, front wall and tail gate of the pick-up truck bed. The bed liner panels are secured to the pick-up truck bed by a releasable system, such as VELCRO, which is a registered trademark for a hook and loop fastener system. Each interior surface of the bed liner panel is provided with a series of regularly spaced, vertically oriented grooves. Cargo restraint is achieved by selectively inserting a planar retaining member, such as a predetermined number of stacked 2.times.4's, into opposing grooves on opposite sides of the bed. This may be either longitudinal between the front wall and the tailgate, or transverse between the side-walls.

U.S. Pat. No. 5,265,993 which issued to Wayne on Nov. 30, 1993 for a Truck Bed Divider System which discloses a truck bed divider system for placement within the bed of a truck includes at least one primary divider and at least one secondary divider. The primary dividers include brackets at each end that provide a frictional fit against the interior side of the walls of the bed of the truck. By a slotted interrelationship, the primary dividers are situated within the bed at their preferred positions and are thereafter adjusted by extending the brackets outward relative to the divider body to their maximum extent whereby they are pressed against the side of the bed and held thereto by tension, thus eliminating the need for fasteners. The secondary dividers are provided with hooks at their ends and are interfittable between the primary dividers by being hooked into slots perpendicularly defined in the body of the primary dividers. Both primary and secondary dividers are preferably provided with shelf extensions for the placement of shelves thereupon.

U.S. Pat. No. 5,411,355 which issued to Gosnell et al. on May 2, 1995 for a Utility Vehicle Bed Partition discloses a bed partition arrangement for a utility vehicle such as a pickup truck in which a flat panel has laterally opposed side edges and a bottom edge. A pair of latches are disposed at the respective side edges of the panel, with each latch including a latch bar for engagement with opposed longitudinally spaced openings in a pair of rails mounted along opposed sidewalls of the vehicle bed. The latch bars are urged by coil springs laterally outwardly of the panel for releasable locking engagement with openings in the side rails, and the latch bars are movable by handles inwardly against the springs for selective positioning of the panel lengthwise of the vehicle bed. Resilient feet are carried along the bottom edge of the panel for compressive frictional engagement with the floor of the vehicle bed when the panel is mounted between the side rails to hold the panel in position and prevent the panel from swinging about the axis of the latches.

U.S. Pat. No. 5,423,463 which issued to Weeks on Jun. 13, 1995 for an Interlock Panel which discloses an interlock panel has a plurality of laterally spaced teeth which define tooth slots and pairs of spaced lugs which define interlock slots. Each tooth slot is aligned with an interlock slot to receive one of the top and bottom area of a panel to provide a double interlock when a pair of panels are joined.

U.S. Pat. No. 5,597,193 which issued to Conner on Jan. 28, 1997 for an Interlocking Panel Truck Bed Liners which discloses an interlocking panel truck bed liner comprises a horizontal grid base formed in a solid planar rectangular configuration. The base has an upper surface and a lower surface. The lower surface includes coupling devices to permit affixation to the floor of a truck bed. The upper surface has a plurality of perpendicularly intersecting, rectangular-shaped horizontal grooves. Four vertical sidewall liners are each formed in a solid planar rectangular configuration with a front surface and a rear surface. The rear surface of each sidewall liner includes coupling devices to permit vertical affixation to the sidewalls and tailgate of a truck. The front surface of each sidewall liner includes vertical grooves positioned in alignment with the grooves in the grid base. A plurality of interlocking panels are each formed in a planar rectangular configuration. Each panel has two identical surfaces. The panels are positioned vertically in an operative orientation and include a plurality of coupling devices. The panels are adapted to couple to each other in parallel and perpendicular orientations. The panels are positioned within the grooves of the sidewall liners and grid base in an operative orientation.

U.S. Pat. No. 5,599,055 which issued to Brown on Feb. 4, 1997 for an Insert for a Pickup Truck Bed which discloses an insert for a pickup truck bed comprised of a truck bed insert comprising a plurality of longitudinally and latitudinally extending rib members. The longitudinally and latitudinally extending rib members together forming a plurality of square openings. The truck bed insert is dimensioned to be received within a truck bed of a pickup truck. A plurality of attachment brackets are adapted for securement of the insert within a pickup truck bed. Lock mechanisms have a key insert through an upper portion. The lock mechanisms have lugs selectively extending outwardly of opposing sides of a lower portion thereof to engage slots within a lower portion of the longitudinally extending rib members of the insert for a truck bed whereby the lugs cooperate with the key insert to selectively engage or disengage the slots.

U.S. Pat. No. 5,788,310 which issued to McKee on Aug. 4, 1998 for a Pickup Truck Bed Liner Dividing System which discloses a new Pickup Truck Bed Liner Dividing System for preventing cargo of various shapes and sizes from moving within a pickup truck bed. The inventive device includes a swaged liner, a plurality of vertical cylindrical cavities within the swaged liner, a plurality of pegs for selectively being positioned within the vertical cylindrical cavities adjacent to cargo, and a storage box for storage of the pegs. The pegs selectively positioned adjacent to the cargo prevent movement of the cargo thereby preventing damage to the cargo and the pickup truck.

U.S. Pat. No. 6,022,062 which issued to Fleenor on Feb. 8, 2000 for a Vehicle Cargo Bed Liner with Cargo Stabilizing Means which discloses a ribbed vehicle cargo bed, including a vehicle cargo bed liner, which contains a means for stabilizing an object during transport. The stabilizing means is created by a reduced floor rib height in an area shaped to hold a cargo object. The area having reduced rib height is adjacently surrounded by a supporting ridge comprising a plurality of cross sectioned rib walls extending essentially perpendicularly from said floor. The supporting ridge provides a barrier which prevents a suitably shaped object situated atop the (recessed) area from sliding during transportation.

U.S. Pat. No. 6,135,527 which issued to Bily on Oct. 24, 2000 for a Cargo Compartment Organizer which discloses a cargo compartment organizer for providing an easily assembled and disassembled cargo organizer includes a bottom panel, side panels, and a top panel having at least one hinged lid, wherein the bottom, top and side panels are coupled together by resilient tracks. In an alternate embodiment, the bottom panel and side panels include cutouts to accommodate wheel wells such as are commonly found in pick-up style vehicles.

U.S. Pat. No. 6,176,657 which issued to Romph on Jan. 23, 2001 for a Cargo Restraint Assembly for a Vehicle Cargo Bed which discloses a cargo restraint assembly is for a vehicle cargo bed and includes a vehicle cargo bed liner adapted to lie on the floor of the cargo bed. The liner has spaced parallel grooves extending from the rear to the front of the liner and defined by spaced parallel upstanding ribs. The assembly also includes a cargo stop block having a rear end, opposite front end, top, bottom and opposing sides. The block bottom has parallel spaced forwardly extending ribs defining spaced parallel grooves therebetween. The block ribs and grooves are adapted to mate with the grooves and ribs of the bed liner. The assembly further includes a stop block lock which is adapted to draw the block laterally to engage the sides of the block depending ribs with the sides of the upstanding ribs of the bed liner in order to secure the block in place on the bed liner. In one embodiment the lock has a body with a depending rib which fits in a bed liner groove. The lock is adapted to be positioned adjacent a side of the block and includes a transverse draw screw or threaded draw bolt passing into the block. In another embodiment the lock includes a clamp, one portion of which is secured to the lock body and a second portion of which is secured to the block, with a draw screw spanning the two portions of the clamp. In a further embodiment, the block is split about vertically into two parts and the lock is in the form of a clamp having two portions, one portion being connected to one of the block parts and the other portion being connected to the other of the block parts, with a draw screw spanning the two clamp portions. The sides of the depending block ribs can bear teeth to facilitate engagement with the bed liner ribs. Alternatively, the sides of the block ribs can bear flexible resilient strips which act as wedges to help hold the assembly together.

U.S. Pat. No. 6,478,356 which issued to Wayne on Nov. 12, 2002 for a Cargo Area Structure which discloses a truck bed or bedliner for a cargo carrier includes a transverse divider received in sidewall slots and a loop engaging a side of the divider to secure the divider in position.

U.S. Pat. No. 6,644,712 which issued to Rafi-Zadeh on Nov. 11, 2003 for a Disassemblable Orthogonal Multilevel Storage Assembly Configurable into Variable Sized Storage Chambers for Vehicle Passenger Compartments and Pickup Truck Beds which discloses a disassemblable orthogonal multilevel storage assembly is configurable into variable sized storage chambers for installation in vehicle passenger compartments and pickup truck beds. The assembly uses a plurality of telescoping panels each having a plurality of apertures spaced apart at equal intervals along designated lines in the panels such that the panels can be interconnected when positioned in horizontal and vertical orientations adjacent one another. Tabs are formed along selected edges of the panels and include a plurality of apertures spaced apart at equal intervals to facilitate interconnection of panels. The storage assembly can be configured to be installed in a passenger compartment when seats are removed from the passenger compartment.

U.S. Pat. No. 6,890,138 which issued to Myrick on May 10, 2005 for a Modular Pegboard Cargo Restraint which discloses a pegboard system for constraining items of cargo in transit has one or more pegboards to cover a cargo support area, the pegboards having an upper surface with openings for pegs, and a plurality of pegs sized to fit into the openings in the pegboards to constrain the items of cargo from substantial lateral movement. In some cases there are elastic top elements for pegs to protect items of cargo, and straps between pegs to aid in constraint of the items of cargo.

U.S. Pat. No. 6,979,037 which issued to Morrison on Dec. 27, 2005 for a Collapsible Cargo Organizer which discloses a cargo apparatus (10) including a base (16) having at least one end (30) and at least one side (28), with the at least one end having at least one laterally inside post (20) extending therefrom, and with the at least one side having at least one laterally outside post (18) extending therefrom. At least one end bracket (24) and at least one side bracket (22) are pivotably and translatably mounted to the base, wherein the brackets each have at least one support leg (38, 44) with a mounting end (42, 48). The mounting end pivotably mounts to its respective post on the base between open and closed positions and also translatably mounts to its respective post between an unlocked position distal the post and a locked position proximal the post, whereby the apparatus is collapsible to a closed portable position, and is foldable to a sturdy, open position.

Canadian Patent Application No. 2,062,499 which was published on Jan. 1, 1993 to Wayne for a Cargo Area Structure which discloses a cargo area structure for a pickup truck includes partitions for selectively dividing the cargo area structure into a number of smaller areas of various configurations to retain cargo of various sizes against movement as the cargo is being transported by the truck, and a closure structure for enclosing the selected cargo area structure with a movable cover.

### SUMMARY OF THE INVENTION

In summary, the modular cargo containment wall system according to one aspect of the present invention includes a floor or floor liner, and first and second types of containment walls referred to herein alternatively as first and second wall members. The floor or floor liner has upwardly disposed parallel arrays of first tenons mounted thereon. The floor or floor liner are alternatively referred to herein are intended to encompass all manner of flooring or floor liners, whether or not removable.

The first and second wall members are substantially rigid and may be planar. Each may have arrays of first mortises formed along bottom edges thereof. As used herein, the terms mortise and tenor are intended to include types of joints in which a hole, slot or groove (the mortise) in one member such as one of the compartment walls, is fitted with a projection such as a pin (the tenon) from a second member such as another compartment wall or the corrugated floor. It is expressly intended that mortise and tenon joints that fall within the scope of the present invention are not to be limited however to those few examples as other forms of mortise and tenon joints would also work as would be known to one skilled in the joinery arts.

The arrays of first mortises each include spaced apart first mortises equally spaced for releasable mounting onto equally spaced apart first tenons spaced apart by an equal spacing in the arrays of first tenons. The arrays of first tenons are also equally spaced apart from one another by equal spacing so that the arrays of first mortises are releasably mountable to the first tenons when the arrays of first mortises are aligned parallel with the arrays of first tenons and when the arrays of first mortises are aligned perpendicularly to the arrays of first tenons.

The first wall member may be elongate and adapted for releasable mounting to the second wall member when in a bracing position adjacent the first wall member. In the bracing position the first and second wall members are substantially orthogonal to one another.

The first and second wall members are adapted for releasable mounting to one another by releasably mating second mortises and second tenons cooperating between the first and second wall members. When the first and second wall members are releasably mounted onto the floor so as to mate the first mortises onto the first tenons, the second tenons are releasably mountable to the second mortises when the first and second wall members are in the bracing position whereby the first wall member is braced substantially vertically by the second wall member.

In one preferred embodiment which provides for recessing or flush-mounting of the first tenons below or flush with the load bearing surface of the floor so as to not damage the first tenons, the floor is at least partially corrugated and includes in the corrugation a parallel spaced apart array of ridges interspersed alternatingly with a parallel spaced apart array of channels, and wherein the arrays of first tenons are mounted in the array of channels. Thus the upper-most surfaces of the first tenons in the arrays of tenons may be substantially flush with upper-most surfaces of the array of ridges. In that embodiment then the bottom edges of the first and second wall members may advantageously be notched so that, when the first or second wall members are mounted perpendicularly to the arrays of first tenons, the notches mate over corresponding ridges in the array of ridges. The second mortises in that embodiment are interspersed along the bottom edges of the first and second wall members between the notches so as to releasably mate onto the first tenons in corresponding channels in the array of channels. Rails may be provided which are sized for mounting into the channels of the array of channels. The rails may be mounted in each of the channels and the first tenons mounted on the rails. Advantageously, the corrugation extends substantially entirely across the floor in the longitudinal and lateral directions. Advantageously, the length of the first wall member is substantially one half of the width of the corrugation in the lateral direction. The corrugation may be longer in the longitudinal direction than the lateral direction.

In one embodiment the second wall member may be a brace which includes a cantilevered arm. The second tenons on the first wall member include a linear spaced apart array of second tenons mounted along, so as to be upwardly disposed from, an upper edge of the first wall member. The second mortises on the brace may include a cantilevered mortise formed in a lower surface of the cantilevered arm. The cantilevered arm may be elevated on the second wall member so as to project the arm and the cantilevered mortise over and onto one of the second tenons of the array of second tenons when the first and second wall members are mounted on the floor.

In one embodiment the second mortises may also include side wall mortises on opposite side surfaces of the first wall member, where the opposite side surfaces extend from and between oppositely disposed substantially vertical side edges of the first wall member. The second tenons may include a side edge tenon projecting substantially horizontally from a substantially vertical side edge of the second wall member corresponding to the cantilevered arm so that when the cantilevered mortise is mounted onto one of the second tenons of the array of second tenons, the side edge tenon mates to a corresponding side wall mortise. The cantilevered arm may project directly from and over an upper end of the side edge of the second wall member.

Advantageously, the second wall member is both a brace and a containment wall having a corresponding second length. The first wall member is a primary containment wall and may have a first length greater than the second length. For example the first length may be at least substantially twice the second length.

The floor may be described as having a longitudinal length and corresponding longitudinal axis or direction, and a lateral width and a corresponding lateral axis or direction. The longitudinal and lateral directions are coplanar in a substantially horizontal plane and perpendicular to one another. The arrays of ridges and channels may extend in the longitudinal direction.

Advantageously, an equal longitudinal spacing between each first tenon in the arrays of first tenons is substantially equal to lateral spacing in the lateral direction between adjacent first tenons in adjacent arrays of first tenons. The first or second wall members may thus each be selectively mountable laterally with their corresponding arrays of the first mortises oriented in the lateral direction or longitudinally with the corresponding arrays of the first mortises oriented in the longitudinal direction. Thus the first wall member is selectively mountable to support a cargo load in either of the lateral or longitudinal directions and, correspondingly, the second wall member is thereby mountable to support the cargo load in either of the longitudinal or lateral directions respectively.

In a preferred embodiment the system includes at least two of the first wall members and at least two of the second wall members. The first wall members each have opposite first and second ends having corresponding first and second side edges respectively. Third tenons may be provided which project from the first side edges of the first wall members. The second side edges may then have third mortises formed therein so that, when two first wall members are mounted abutting on the floor so as to be aligned coplanar to each other, the third tenons on a first of the two first wall members releasably mate with the third mortises on a second of the two first wall members to thereby form one continuous containment wall.

The side wall mortises may include, on each side surface of the first wall member, at least one horizontal array of horizontally spaced apart mortises. The second wall member is selectively mountable to the first wall member by selectively mounting the side edge tenon into one mortise of the horizontal array of horizontally spaced apart mortises to thereby selectively position the second wall member relative to the first wall member when in the bracing position. Two of the second wall members may be selectively mountable to one first wall member or to two abutted first wall members to thereby define a selectively configurable cargo containment compartment between the two second wall members and the portion of the first wall member or members extending therebetween.

In one embodiment the first and second wall members include through-slots in and between opposite side surfaces thereof. The system may further include tethers for mounting through the through-slots for storing or securing the first and second wall members.

### BRIEF DESCRIPTION OF THE DRAWINGS

FIG. 1 is, in perspective view, one set of compartment walls according to one aspect of the present invention mounted onto a floor liner and modularly arranged to support bicycles.

FIG. 2 is, in perspective view, the set of compartment walls of FIG. 1 arranged to restrain three containers carried on the floor liner.

FIG. 3 is, in perspective view, the set of compartment walls of FIG. 1 configured on the floor liner to restrain a set of wheels carried on the floor liner.

FIG. 4 is, in perspective view, the set of compartment walls of FIG. 1 configured to restrain a stack of lumber stacked longitudinally along the box liner.

FIG. 5 is, in perspective view, the set of compartment walls of FIG. 1 configured to restrain a propane bottle resting on the floor liner.

FIG. 6 is, in perspective view, the set of compartment walls of FIG. 1 in their storage position restrained along the sides of the floor liner.

FIGS. 7a and 7b are, respectively, enlarged perspective views of the set of compartment walls of FIG. 6.

FIGS. 8a and 8b are respectively, in bottom perspective view, a long compartment wall and a short compartment wall of the set of compartment walls of FIG. 1.

FIG. 9a is, in partially cut away, partially exploded elevation view, a fastening system for mounting the compartment walls to the floor liner according to one aspect of the present invention.

FIG. 9b is the view of FIG. 9a with the compartment wall mounted down onto the floor liner.

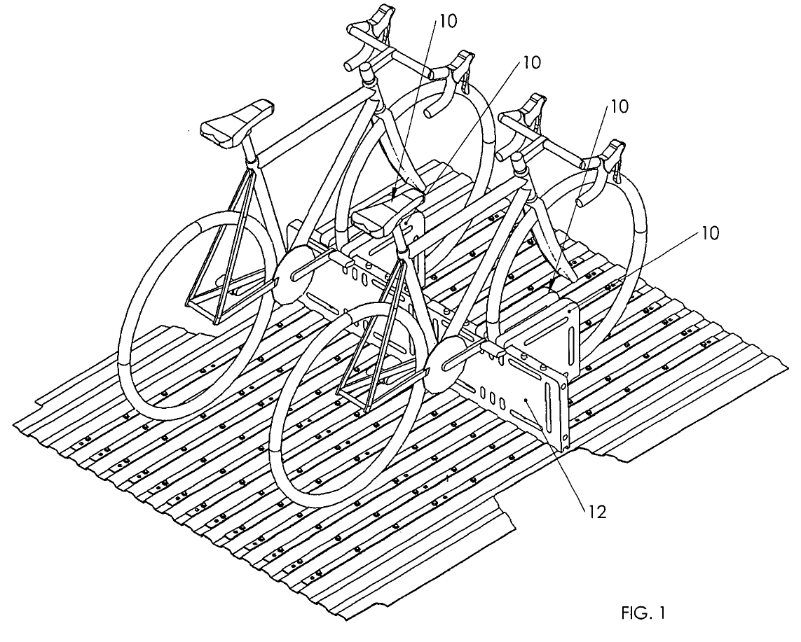

### DETAILED DESCRIPTION OF EMBODIMENTS OF THE INVENTION

With reference to the drawings wherein similar characters of reference denote corresponding parts in each view, the modular cargo containment wall system according to the present invention includes short compartment walls 10 which releasably mate to long compartment walls 12, both of which releasably mount onto corrugated floor liner 14 by means of a mortise and tenon mating system.

As used herein, reference to mortise and tenon mating is intended to include types of joints in which a hole, slot or groove (the mortise) in one member such as one of the compartment walls, is fitted with a projection such as a pin (the tenon) from a second member such as another compartment wall or the corrugated floor.

In the illustrated embodiment which is not intended to be limiting, the tenons are vertical pins 16 mounted in equally spaced apart linear array along rails 18 mounted into the troughs or channels 20 running the length of floor liner 14 in parallel laterally equally spaced array between the parallel ridges 22 of the corrugation of floor liner 14. Pins 16 are thus recessed so that the tops of the pins are for example flush with, or recessed below, the upper surfaces of ridges 22 to thereby protect the pins 16. The ridges thus provide the lead bearing surfaces on which cargo rest, and not on top of the pins 16.

The tenons on compartment walls 12 are the vertical pins 24 mounted in equally spaced apart linear array along the top edge 12a of each compartment wall 12. A further set of tenons in the form of horizontal pins 26 are mounted to one side edge 10a of compartment walls 10.

The mortise component of the illustrated embodiment, which is not intended to be limiting, are holes or bores sized and shaped to snugly fit over their corresponding pins. Thus, holes 28 formed in the underside of cantilevered flange 10b, cantilevered so as to extend from side 10a of compartment wall 10, mates onto a pin 24 extending upwardly from top edge 12a of compartment wall 12. Pins 26 extending horizontally outwardly from side edge 10a may mate into either holes 30 formed in one end of compartment walls 12 and in particular formed into side edges 12b, or pins 26 may mate with slots 32 formed in the oppositely disposed side walls 12d and 12e of compartment walls 12 while simultaneously mounting a corresponding pin 24 into hole 28 so as to mount the compartment wall 10 perpendicularly to the compartment wall 12.

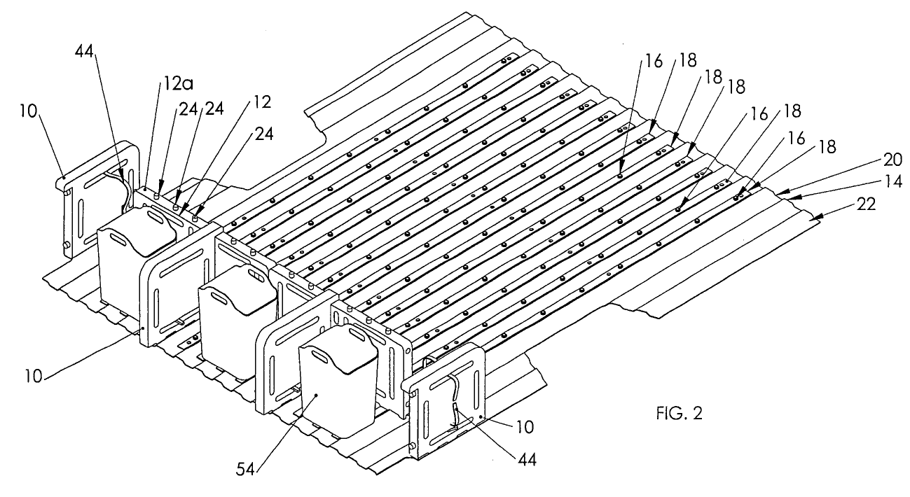

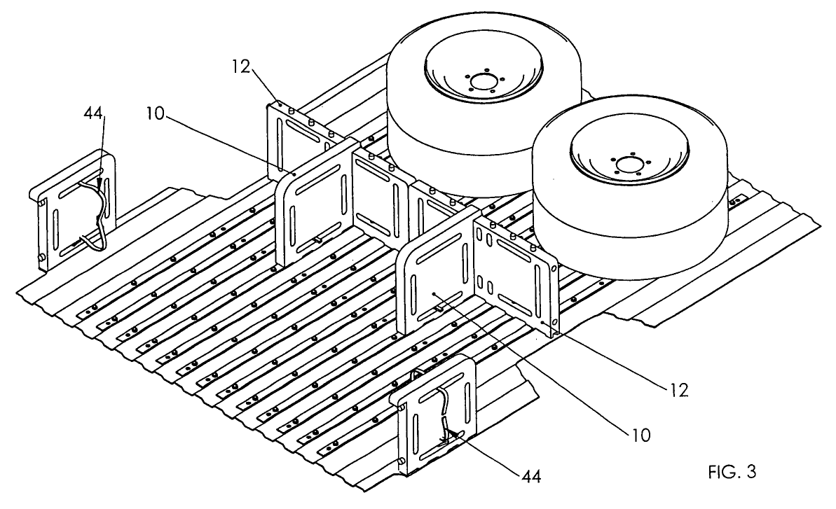

The bottom edge 12f of compartment walls 12 are notched so as to conformably mate over the corrugation of floor liner 14 and in particular snugly over ridges 22 interspersed therebetween by channels 20. Thus notches 34 formed in regularly spaced array along bottom edge 12f mate over corresponding ridges 22 of floor liner 14 so as to seat the downwardly extending flanges 36 interleaved between notches 34 into mating engagement in channels 20 when compartment walls 12 are mounted laterally onto and across floor liner 14. For ease of reference, axis A in FIG. 2 indicates the longitudinal direction of floor liner 14, it being understood that when compartment walls 12 are mounted laterally onto and across floor liner 14, that they each then lie in a plane which is orthogonal to axis A, and when compartment walls 10 are mounted longitudinally onto floor liner 14, it is understood that they are mounted in a vertical plane which is parallel to axis A.

Thus as indicated in the Figures, in one embodiment, for example where box liner 14 lines the floor of a conventional full size pickup truck box, two compartment walls 12 are laterally aligned in a vertical coplanar relationship so as to abut side edge 12c of one wall 12 against side edge 12b of the adjacent wall 12. Thus pins 38 extending from side edge 12c mates with holes 30 in the opposed facing wall 12b of the adjacent compartment wall 12. Half-flanges 36a which are formed at the opposite ends of the array of vertical flanges 36, when the opposed facing side edges 12c and 12b respectively of the pair of compartment walls 12 are mounted in abutting relation, form a complete vertical flange 36 from the abutted pair of half-flanges 36a.

Along the bottom edge 12f are formed a linear equally spaced apart array of holes 40. Each hole is formed in the underside of a corresponding vertical flange 36 so that holes 40 mate onto corresponding pins 16 extending upwardly from rails 18. At the opposite ends of compartment wall 12, and in particular in each of the half-flanges 36a, are formed half-holes 40a so that with the pair of half-flanges 36a abutting the corresponding pair of half-holes 40a together form a complete mortise, that is, a complete hole 40 for snug mounting onto a corresponding pin 16.

Each of the compartment walls 10 and 12 may also include through-slots 42 which extend entirely through the width of a compartment wall 10 or 12. Through-slots 42 may be used for tethering, for example by means of straps 44, of compartment walls against, for example, the inside of a pickup truck box (not shown) when the compartment walls are not in use.

Similar to the bottom edges of compartment walls 12, the bottom edges 10c of compartment walls 10 are also notched along their length so as to interleave notches 46 with downwardly extending vertical flanges 48. Again, an array of holes 50 are formed in the array of downwardly extending vertical flanges so that holes 50 are formed in the lower-most surfaces of vertical flanges 48. Holes 50 mate onto pins 16 when compartment walls 10 are mounted so as to extend longitudinally along channels 20 and mounted to corresponding laterally extending compartment walls 12 to thereby brace the longitudinal and lateral compartment walls when selectively positioned along and across the floor liner 14. Thus the position of the lateral and longitudinally extending compartment walls, whether walls 10 or 12 respectively, may be selectively positioned on floor liner 14 to accommodate different sized loads. For example the loads may include tires 52, containers 54, lumber 56 or propane bottles 58 to name just a few examples of the many loads which may be accommodated by the interchangeable and repositionable mounting of compartment walls 10 and 12 either singularly or in multiples including multiple linear arrays of compartment walls 10 or 12.

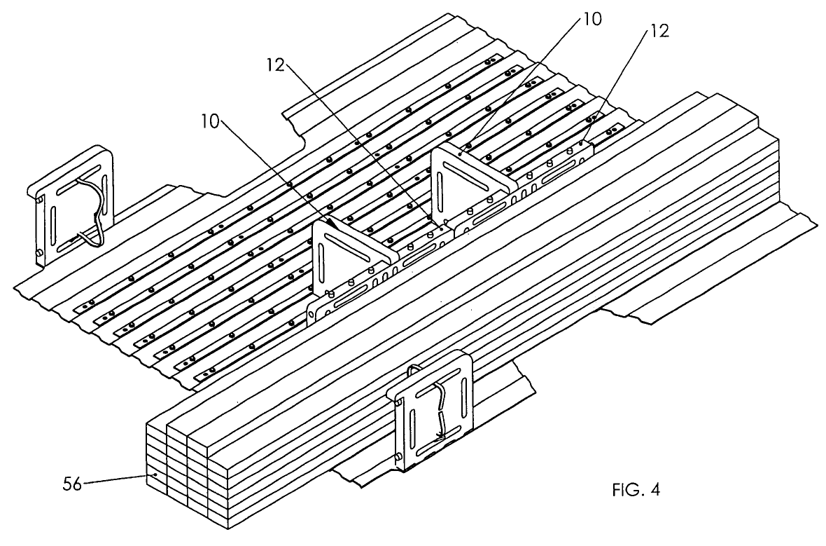

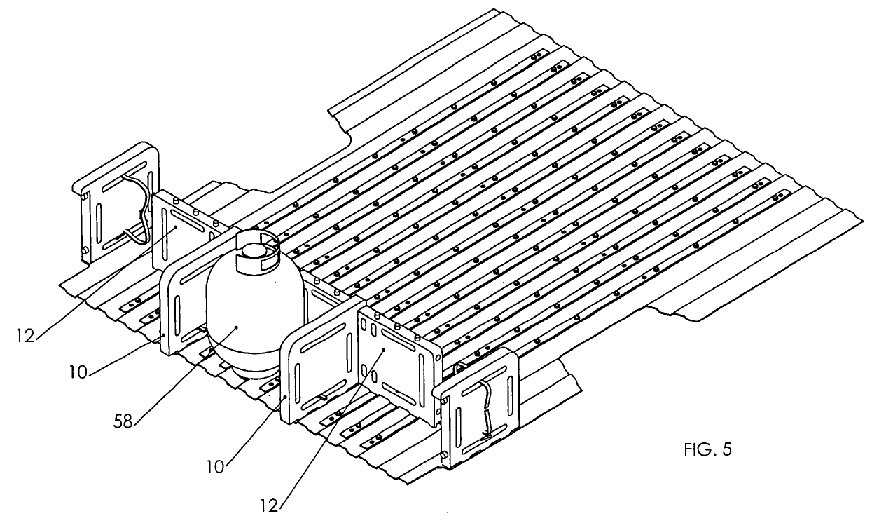

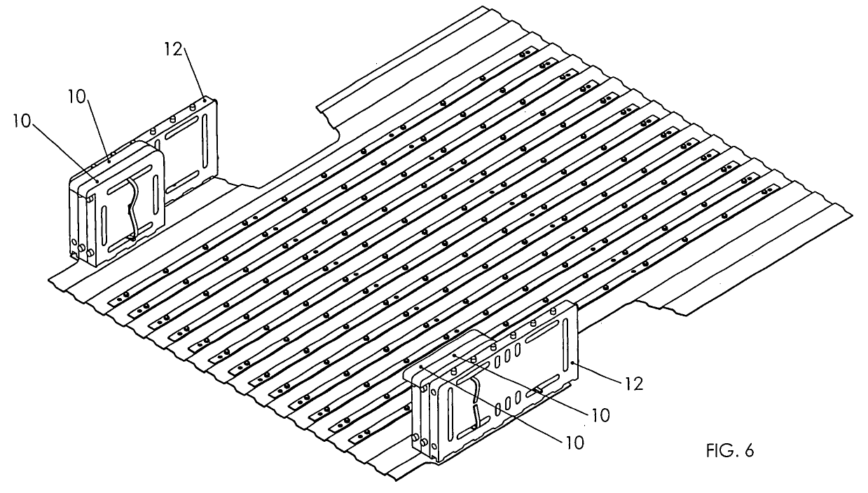

Thus in terms of relative sizes, the longer compartment wall 12 may for example extend approximately one half of the distance laterally across floor liner 14 so that substantially the entire distance across the floor liner may be compartmentalized by merely using two linearly arranged compartment walls 12, each of which braced by for example a single or a pair of the shorter compartment walls 10. The shorter compartment walls 10 may for example be approximately one half the length of compartment walls 12. This however is not intended to be limiting as compartment walls of different lengths may also be employed so long as the interchangeable nature of the walls is maintained so that for example as seen in FIG. 4, compartment walls 12 may be oriented so as to extend longitudinally to brace lumber 56, and compartment walls 10 then being oriented laterally to brace compartment walls 12. This interchange ability is accomplished by the use of the array of holes along the bottom edges of the compartment walls being equally spaced whether along the bottom edge of a compartment wall 10 or a compartment wall 12. Further, the interchange ability is assisted by the equally spaced matrix of pins 16 on rails 18 wherein the lateral and longitudinal distances between adjacent pins 16 are the same thereby allowing for a particular compartment wall to mate onto the pins whether the compartment wall is oriented longitudinally or laterally across floor liner 14.

As illustrated, and again not intending to limiting, a useful combination or set of compartment walls for use in for example a single pickup truck, may advantageously include two compartment walls 12 and four compartment walls 10.

As also illustrated, compartment walls 10 and 12 may be configured to brace one or more bicycles in an upright, longitudinally aligned position. By way of example, the front wheels of the bicycles may be snugly sandwiched between a pair of compartment walls 10 which are themselves mounted orthogonally to laterally extending compartment wall 12, compartment walls 10 and 12 mounted releasably and rigidly down onto the floor liner.

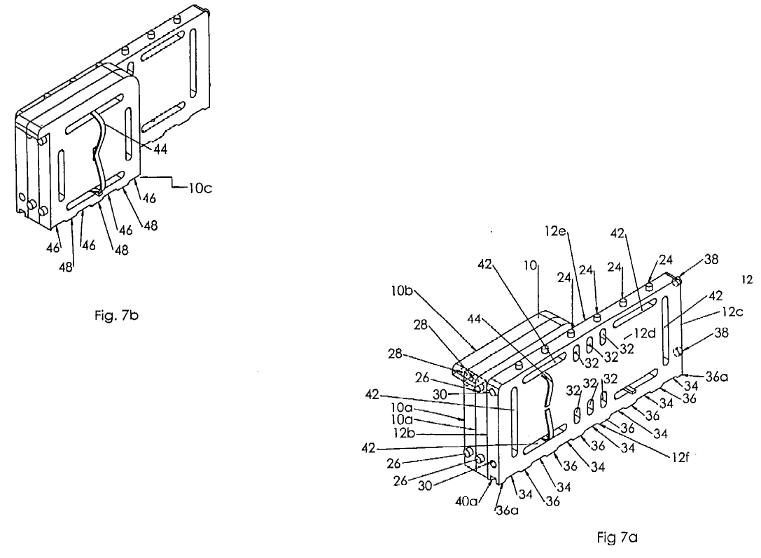

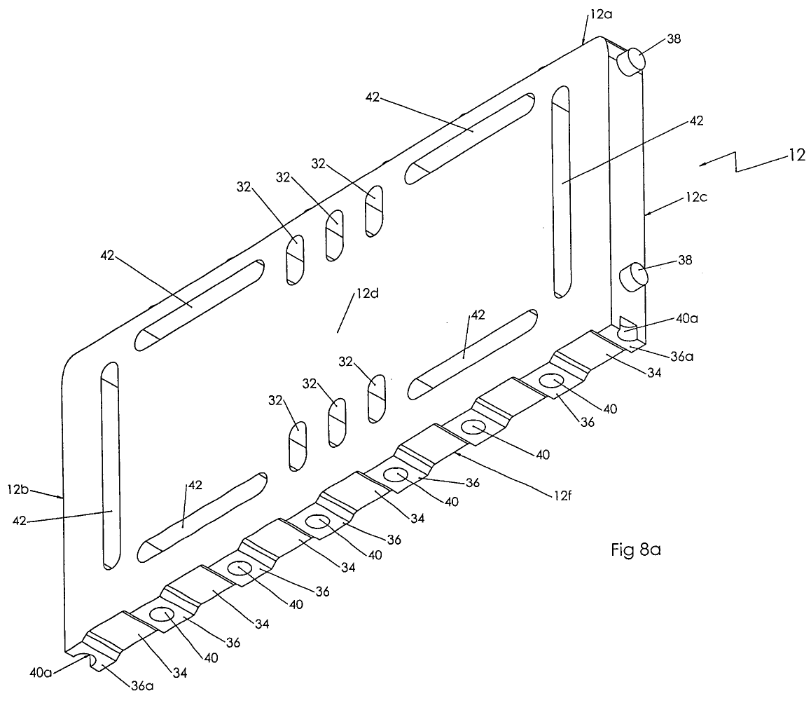

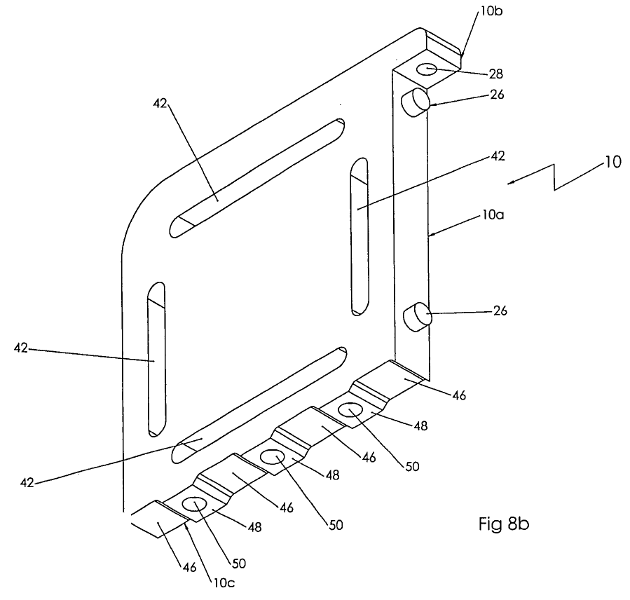

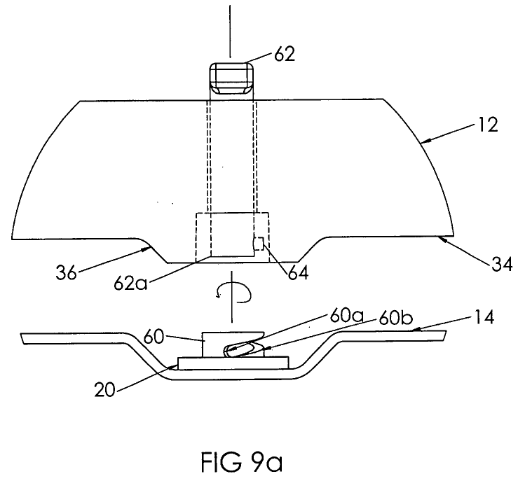

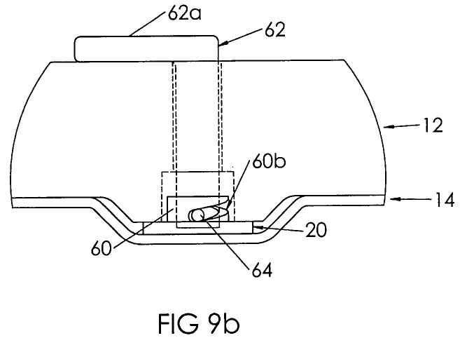

In one embodiment which is not intended to be limiting, as seen in FIGS. 7 and 8, a compartment wall may be secured vertically downwardly onto the floor liner by means of a helical female coupling 60 releasably mating with a vertically downwardly extending shaft 62. A pin 64 extends horizontally outwardly from one side of the bottom end of shaft 62 so that, with the lower end 62a of shaft 62 journalled into a corresponding vertically extending bore in coupling 60, pin 64 engages the upper end of a helical slot 60b in the side wall of coupler 60. Shaft 62 is then rotated so as to translate pin 64 helically downwardly along slot 60b thereby drawing shaft 62 and the compartment wall in which it is mounted downwardly down onto the floor liner into its releasably locked and mounted position as seen in FIG. 8. In one embodiment, shaft 62 includes a handle 62a to assist a user rotating the shaft so as to releasably lock pin 64 and the shaft down onto coupler 60.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A modular cargo containment wall system comprising:
a floor having mounted thereon upwardly disposed parallel arrays of first tenons mounted to said floor,
substantially rigid and planar first and second wall members each having arrays of first mortises formed along bottom edges thereof, said arrays of first mortises each including spaced apart first mortises equally spaced for releasable mounting onto equally spaced apart first tenons spaced apart by an equal spacing in said arrays of first tenons,
and wherein said arrays of first tenons are also said equally spaced apart from one another by said equal spacing so that said arrays of first mortises are releasably mountable to said first tenons when said arrays of first mortises are aligned parallel with said arrays of first tenons and when said arrays of first mortises are aligned perpendicularly to said arrays of first tenons,
said first wall member elongate and adapted for releasable mounting to said second wall member when in a bracing position adjacent said first wall member, wherein in said bracing position said first and second wall members are substantially orthogonal to one another, said first and second wall members being adapted for said releasable mounting to one another by releasably mating second mortises and second tenons cooperating between said first and second wall members wherein, when said first and second wall members are releasably mounted onto said floor so as to mate said first mortises onto said first tenons, said second tenons are releasably mountable to said second mortises when said first and second wall members are in said bracing position whereby said first wall member is braced substantially vertically by said second wall member.

2. The system of claim 1 wherein said floor is at least partially corrugated and includes in said corrugation a parallel spaced apart array of ridges interspersed alternatingly with a parallel spaced apart array of channels, and wherein said arrays of first tenons are mounted in said array of channels.

3. The system of claim 2 wherein upper-most surfaces of said first tenons in said arrays of tenons are substantially flush with upper-most surfaces of said array of ridges, and wherein said bottom edges of said first and second wall members are notched with notches so that, when said first or second wall members are mounted said perpendicularly to said arrays of first tenons, said notches mate over corresponding ridges in said array of ridges, and wherein said second mortises are interspersed along said bottom edges between said notches so as to releasably mate onto said first tenons in corresponding channels in said array of channels.

4. The system of claim 1 wherein said second wall member includes a cantilevered arm and wherein said second tenons include a linear spaced apart array of second tenons mounted along, so as to be upwardly disposed from, an upper edge of said first wall member, and wherein said second mortises include a cantilevered mortise in a lower surface of said cantilevered arm, said cantilevered arm elevated on said second wall member so as to project said arm and said cantilevered mortise over and onto one of said second tenons of said array of second tenons when said first and second wall members are mounted on said floor.

5. The system of claim 4 wherein said second mortises include side wall mortises on opposite side surfaces of said first wall member, said opposite side surfaces extending from and between oppositely disposed substantially vertical side edges of said first wall member, and wherein said second tenons include a side edge tenon projecting substantially horizontally from a substantially vertical side edge of said second wall member corresponding to said cantilevered arm so that when said cantilevered mortise is mounted onto one of said second tenons of said array of second tenons said side edge tenon mates to a corresponding side wall mortise of said side wall mortises.

6. The system of claim 5 wherein said cantilevered arm projects directly from and over an upper end of said side edge of said second wall member.

7. The system of claim 1 wherein said second wall member is both a brace and a containment wall having a corresponding second length, and wherein said first wall member is a primary containment wall having a first length greater than said second length.

8. The system of claim 7 wherein said first length is at least substantially twice said second length.

9. The system of claim 8 wherein said floor has a longitudinal length and corresponding longitudinal direction, and a lateral width and a corresponding lateral direction, wherein said longitudinal and lateral directions are coplanar in a substantially horizontal plane and perpendicular to one another, and wherein said floor is at least partially corrugated and includes in said corrugation a parallel spaced apart array of ridges interspersed alternatingly with a parallel spaced apart array of channels, and wherein said arrays of first tenons are mounted in said array of channels, and wherein said arrays of ridges and channels extend in said longitudinal direction.

10. The system of claim 9 wherein an equal longitudinal spacing between each said first tenon in said arrays of first tenons is substantially equal to lateral spacing in said lateral direction between adjacent said first tenons in adjacent arrays of said first tenons of said arrays of first tenons,
and wherein said first or second wall members are each selectively mountable laterally with their corresponding arrays of said first mortises oriented in said lateral direction or longitudinally with said corresponding arrays of said first mortises oriented in said longitudinal direction, whereby said first wall member is selectively mountable to support a cargo load in either of said lateral or longitudinal directions and, correspondingly, said second wall member is thereby mountable to support the cargo load in either of said longitudinal or lateral directions respectively.

11. The system of claim 1 wherein said first and second wall members include at least two of said first wall members and at least two of said second wall members, and wherein said first wall members each have opposite first and second ends having corresponding first and second side edges respectively, and wherein third tenons project from said first side edges and wherein said second side edges have third mortises formed therein so that, when two first wall members of said at least two first wall members are mounted abutting on said floor so as to be aligned coplanar to each other, said third tenons on a first of said two first wall members releasably mate with said third mortises on a second of said two first wall members to thereby form one continuous containment wall.

12. The system of claim 10 further comprising rails sized for mounting into channels of said array of channels, wherein said rails are mounted in each said channel of said array of channels and wherein said first tenons are mounted on said rails.

13. The system of claim 10 wherein said first and second wall members include at least two of said first wall members and at least two of said second wall members, and wherein said first wall members each have opposite first and second ends having corresponding first and second side edges respectively, and wherein third tenons project from said first side edges and wherein said second side edges have third mortises formed therein so that, when two first wall members of said at least two first wall members are mounted on said floor so as to be aligned coplanar to each other, said third tenons on a first of said two first wall members releasably mate with said third mortises on a second of said two first wall members to thereby form one continuous containment wall.

14. The system of claim 13 wherein said corrugation extends substantially entirely across said floor in said longitudinal and lateral directions.

15. The system of claim 14 wherein said first length is substantially one half of the width of said corrugation in said lateral direction.

16. The system of claim 14 wherein said corrugation is longer in said longitudinal direction than said lateral direction and wherein said first length is substantially one half of the width of said corrugation in said lateral direction.

17. The system of claim 5 wherein said side wall mortises include, on each said side surface, at least one horizontal array of horizontally spaced apart mortises wherein said second wall member is selectively mountable to said first wall member by selectively mounting said side edge tenon into one mortise of said at least one horizontal array of horizontally spaced apart mortises to thereby selectively position said second wall member relative to said first wall member when in said bracing position.

18. The system of claim 17 wherein two of said second wall members are selectively mountable to said first wall member to thereby define a selectively configurable cargo containment compartment between said two of said second wall members and a portion of said first wall member extending therebetween.

19. The system of claim 1 wherein said first and second wall members include through-slots in and between opposite side surfaces thereof, said system further comprising tethers for mounting through said through-slots for storing or securing said first and second wall members.

20. The system of claim 1 wherein said first mortises are holes and said first tenons are pins sized for snugly journalled mating in said holes.
